(19) United States
(12) Patent Application Publication
(10) Pub. No.: US 2009/0268927 A1
(43) Pub. Date: Oct. 29, 2009

(54) Fuse

(76) Inventor: Theodoros Asimakopoulos, Silver Spring, MD (US)

Correspondence Address: Theodoros Asimakopoulos, 3703 Jeffry St., Silver Spring, MD, 20906, US

(21) Appl. No.: 12/387,103

(22) Filed: Apr. 28, 2009

Related U.S. Application Data
(63) Continuation of application No. 61/125,933, filed on Apr. 29, 2008.

(51) Int. Cl. G10H 1/00

(52) U.S. Cl. 381/118

(57) ABSTRACT

The invention fuse is a new type of guitar amplifier. This new amp allows for digital chips to be plugged into the amp and to be played. The amp processes the digital chips and guitar player can play whatever is stored on digital chips. This allows for the buying of chips to play whatever is liked and the amp processes the digital chips that store the amp sounds when guitar is played. The digital chips store sounds that are plugged into the amp.

The invention fuse is a new type of guitar amplifier. This new amp allows for digital chips to be plugged into the amp and to be played. The amp processes the digital chips and guitar player can play whatever is stored on digital chips. This allows for the buying of chips to play whatever is liked and the amp processes the digital chips that store the amp sounds when guitar is played. The digital chips store sounds that are plugged into the amp.

### BACKGROUND OF THE INVENTION

The old way of playing guitar is now over. Now you can go to the store and buy digital chips that you insert into amplifier and play whatever is on digital chips. The old way only stored sound in the amp. This new amplifier allows for the digital chips to be processed. Digital chips can now be bought separately that are plugged into amplifier.

### BRIEF SUMMARY OF THE INVENTION

The invention fuse is a new type of guitar amplifier. This new amp allows for digital chips to be plugged into the amp and to be played. The amp processes the digital chips and guitar player can play whatever is stored on digital chips. This allows for the buying of chips to play whatever is liked and the amp processes the digital chips that store the amp sounds when guitar is played. The digital chips store sounds that are plugged into the amp.

### DETAILED DESCRIPTION OF THE INVENTION

The invention fuse is a new type of guitar amplifier. This new amp allows for digital chips to be plugged into the amp and to be played. The amp processes the digital chips and guitar player can play whatever is stored on digital chips. This allows for the buying of chips to play whatever is liked and the amp processes the digital chips that store the amp sounds when guitar is played. The digital chips store sounds that are plugged into the amp.

1. New Amplifier that allows for plugging in of digital chips that the amp processes and are played by the amp.

2. Digital Chips that are plugged into amp and are processed (played) by amplifier.
